(19) United States
(12) Patent Application Publication
(10) Pub. No.: US 2025/0028128 A1
(43) Pub. Date: Jan. 23, 2025

(54) SYSTEMS AND METHODS FOR FREE-SPACE OPTICAL COMMUNICATION

(71) Applicant: Rensselaer Polytechnic Institute, Troy, NY (US)

(72) Inventor: Moussa N'Gom, Guilderland, NY (US)

(73) Assignee: Rensselaer Polytechnic Institute, Troy, NY (US)

(21) Appl. No.: 18/582,176

(22) Filed: Feb. 20, 2024

Related U.S. Application Data
(60) Provisional application No. 63/450,547, filed on Mar. 7, 2023.
(60) Provisional application No. 63/460,468, filed on Apr. 19, 2023.

(51) Int. Cl. G02B 6/42; G02B 6/35; H04B 10/11

(52) U.S. Cl. CPC G02B 6/4203; G02B 6/3512; H04B 10/11

(57) ABSTRACT

A system for free-space optical communication includes a first light source configured to emit an information signal, a spatial light modulator configured to shape the information signal, a second light source configured to emit a plurality of beam pulses, at least one spiral phase plate configured to convert each of the plurality of beam pulses into a plurality of vortical beam filaments, and a mirror coupler configured to combine the information signal and the plurality of vortical beam filaments to form a multi-filament beam having the plurality of vortical beam filaments embedded within the information signal. When the multi-filament beam passes through an optically obstructed space the plurality of vortical beam filaments are configured to clear at least one channel in the optically obstructed space for the information signal to pass through.

### CROSS REFERENCE TO RELATED APPLICATION(S)

This application claims the priority benefit of U.S. Provisional Patent Application No. 63/450,547, filed Mar. 7, 2023, and U.S. Provisional Patent Application No. 63/460,468, filed Apr. 19, 2023, the contents of which are incorporated by reference herein as if disclosed in their entireties.

### STATEMENT REGARDING FEDERALLY SPONSORED RESEARCH AND DEVELOPMENT

The present invention was made with government support under Grant No. HM04762010012 awarded by the National Geospatial Intelligent Agency. The government has certain rights in the invention.

### FIELD

The present technology relates generally to the field of optical communications, and more particularly, to generating obstruction-free channels for free-space optical communications.

### BACKGROUND

The light-based communication between orbiting satellites and the Earth's surface offers the prospect of significantly increasing space to ground data rates and constitutes a key element in the future for secure worldwide quantum communication networks. Free space optical links between the Earth and space referred to as free-space optical communication (FSO) face a persistent nemesis in the form of atmospheric clouds. Compared to radio frequency (RF) communication, FSO operates at higher frequencies with wide-open bandwidth, resulting in significantly higher capacity communication links. The randomness in size and position of water droplets leads to substantial scattering of the optical energy and quickly scrambling the signal encoded in laser beams. The amplitude fluctuation and wavefront distortion caused by atmospheric turbulence can also severely degrade coupling efficiency and increase the bit error rate. This barrier is traditionally surmounted by increasing the number of networked ground stations, a very complex and expensive solution. Early attempts to clear the sky from fog and clouds involved CO₂ lasers to increase visibility have been realized. However, high energy is required to vaporize and shatter water drops.

Thus, a need exists for improved systems and methods of free-space optical communication that address at least some of the problems described above.

### SUMMARY

According to an embodiment of the present technology, a system for free-space optical communication is provided. The system includes a first light source configured to emit an information signal, a spatial light modulator configured to shape the information signal, a second light source configured to emit a plurality of beam pulses, at least one spiral phase plate configured to convert each of the plurality of beam pulses into a plurality of vortical beam filaments, and a mirror coupler configured to combine the information signal and the plurality of vortical beam filaments to form a multi-filament beam having the plurality of vortical beam filaments embedded within the information signal. When the multi-filament beam passes through an optically obstructed space the plurality of vortical beam filaments are configured to clear at least one channel in the optically obstructed space for the information signal to pass through.

In some embodiments, the spatial light modulator has a Laguerre-Gaussian phase mask applied thereon for shaping the information signal.

In some embodiments, the at least one spiral phase plate is a fused silica phase plate.

In some embodiments, an iris is positioned between the second light source and the at least one spiral phase plate. The iris is configured to set a diameter of the beam pulses.

In some embodiments, the first light source is a continuous wave laser.

In some embodiments, the second light source is a femtosecond pulsed laser.

In some embodiments, the at least one channel is substantially cylindrical. In some embodiments, the at least one channel includes a first cylindrical channel and at least one second annular channel.

In some embodiments, the mirror coupler is a dichroic mirror.

In some embodiments, a beam expander is positioned between the first light source and the spatial light modulator, and a collimator is positioned between the spatial light modulator and the mirror coupler.

In some embodiments, the information signal has an annular profile.

In some embodiments, the optically obstructed space includes a gaseous medium saturated with condensed water vapor, such as air or a portion of the atmosphere filled with clouds and/or fog.

According to another embodiment of the present technology, a method of free-space optical communication is provided. The method includes emitting an information signal from a first light source; shaping, via a spatial light modulator, the information signal; emitting a plurality of beam pulses from a second light source; converting, via at least one spiral phase plate, each of the plurality of beam pulses into a plurality of vortical beam filaments; combining, via a mirror coupler, the information signal and the plurality of vortical beam filaments to form a multi-filament beam having the plurality of vortical beam filaments embedded within the information signal; and directing the multi-filament beam through an optically obstructed space. When the multi-filament beam passes through the optically obstructed space the plurality of vortical beam filaments clear at least one channel in the optically obstructed space for the information signal to pass through.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements. Dimensions noted on the drawings are included by way of example only and are not intended to limit the scope of the present technology.

FIG. 1 illustrates transparent channels created by a multi-filament structure according to embodiment of the present technology that allow the information signal to propagate through cloud or fog. The main figure illustrates the filaments clearing two channels as it propagates through the cloud; the information signal is transmitted through these channels. The inset (a-c) illustrates the evolution of the refractive index change induced in the cloud by a single LG femtosecond pulse. The water droplets that form the cloud are illustrated in the area surrounding the filament as short strips. (a) The generated shock waves clear the water droplets from the region surrounding the filaments, creating a transparent Channel2 (CH2). The boundary of CH2 is marked by the dashed circle. The shock waves also interact at the center of the structure, increasing the local index of refraction and creating Channel1 (CH1). (b) The acoustic waves dissipate, but localized heating of air causes a drop in density creating a ring of lower refractive index. This ring surrounds a higher density central region. (c) Dissipation of heat after several hundred microseconds leads to a smoother refractive index profile of CH1. CH2 created by the shock waves has a lifetime on the order of several milliseconds. The order of magnitude timescales at each stage of channel evolution is provided. The inset (d-f) illustrates the information signals LG_{0,1}, LG_{4,0} and LG_{6,0} respectively. The inset (g-i) illustrates the spatial profile of each information signal coupled with a multi-filament structure. The inset (g) illustrates the arrangement of filaments between the Gaussian center and the annular beam.

FIG. 2 is a schematic view of a system of free-space optical communication according to an embodiment of the present technology. The Gaussian beam generated by the laser is converted to a Laguerre-Gaussian (LG) beam using a fused silica spiral phase plate (SPP) and focused by a lens with focal length f=2.5 m. An information signal emitted at 543 nm is shaped by an LG phase mask applied with an spatial light modulator (SLM). The filament driver and the information signal are combined using a dichroic mirror (DM1) and co-propagate through the cloud chamber. After filtering out the residual filament driver beam with DM2 and a series of bandpass filters, the information signal is imaged by an sCMOS camera. The inset shows a side image of the multi-filament beam propagating through the cloud chamber.

FIG. 3 shows the beam profile of the information signal beam generated by the SLM: (a) LG_{0,1}, (b) LG_{4,0}, and (c) LG_{6,0}.

FIG. 4 shows experimental results with the multi-filament structure generated by the LG_{1,0} SPP. The images in the left column (a, d, & g) show each information signal (LG_{0,1}, LG_{4,0}, and LG_{6,0}, respectively) before the filament is introduced. The middle column (b, c, & h) shows the information signal after the filament is introduced. The right column (c, f, & i) shows the enhancement factor calculated for each pair of information signals in the respective row.

FIG. 5 shows experimental results with the multi-filament structures generated by the LG_{5,0} SPP. The images in the left column (a, d, & g) show each information signal (LG_{0,1}, LG_{4,0}, and LG_{6,0}, respectively) before the filament is introduced in the cloud. The middle column (b, c, & h) shows each information signal after the filament is introduced in the cloud chamber. The right column (c, f, & i) maps the enhancement factor achieved for each information signal.

FIG. 6 is a schematic view of a system of free-space optical communication according to an embodiment of the present technology. (a) Schematic of the experimental setup. L, lens f=2-m; BE, beam expander; SLM, spatial light modulator; I, Iris; DM, dichroic mirror; IF, interference filters; ND, neutral density filters; and MC, mirror coupler. The structured light beam generated by the SLM is coupled with the filament by the MC before entering the cloud chamber. After filtering out the femtosecond pulse with DM, IF, and ND, the structured light is imaged by an sCMOS camera. (b) Side view picture of the filament (glowing line) in the air with an arrow line as a guide. (c) Filament propagates through the chamber containing a sparse cloud. (d) Image of the MC.

FIG. 7 shows the transmission of the signal through the chamber full of air and cloud. (a) Filament alone was imaged after it propagated through the chamber. (b) Signal alone through the cloud chamber. (c) Signal (LG_{12,0}) through the chamber full of air. (d) Signal coupled with the filament through the cloud chamber. The filters were removed for this measurement. (c) and (f) Intensity profile across the diameter of the signal alone in air and coupled with the filament through the cloud chamber, respectively. (g) The transmission of the signal through the cloud chamber taken by the PMT. The shaded slice shows the pump (filament) “on” and the white slices show the pump “off.”

FIG. 8 shows mode conversion to demonstrate OAM conservation: (a) LG_{12,0}; signal beam transmitted in air; (b) signal beam coupled with the filament through the cloud chamber. (c) Using the tilted lens method, the initial signal is converted to its corresponding HG^{45°} mode. d) The same mode conversion is done for the signal beam transmitted through the cloud chamber. For the last conversion, the filament was completely block.

### DETAILED DESCRIPTION

The emergence of femtosecond (fs) terawatt class lasers is an opportunity to reconsider FSO through dense clouds or fog with a fundamentally different approach: laser filamentation. Filamentation is a phenomenon describing a long thin plasma string (the filament), produced by a balance between the optical Kerr effect and plasma defocusing. Laser filaments are self-sustained of around a dozen micrometers in diameter and up to hundreds of meters in length, greatly extending the traditional linear diffraction limit. The creation of the filament is accompanied by an expanding shock wave that displaces water droplets in its immediate vicinity to create a cylindrical channel within which the signal beam can travel unobstructed.

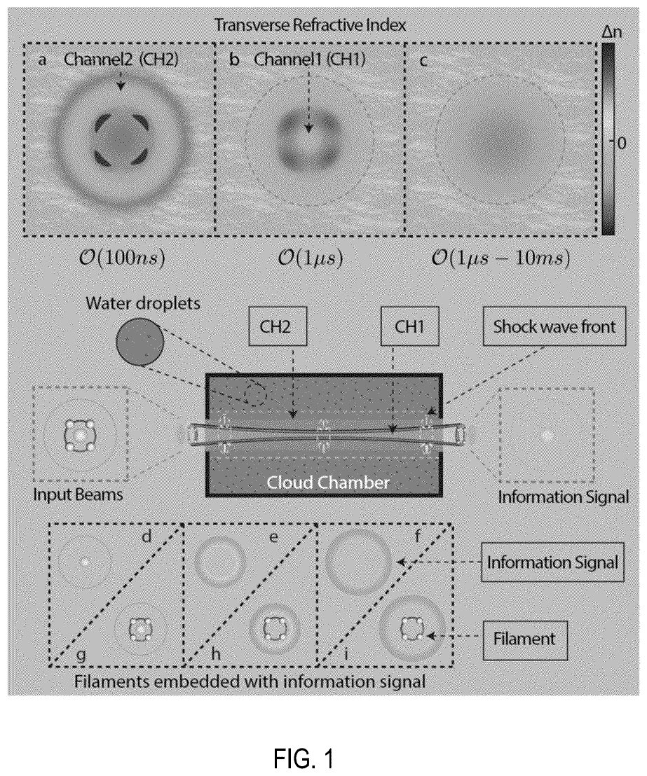

Vortical femtosecond pulses generate a circular distribution of filaments. FIGS. 1A-1C illustrate the mechanism by which the dual channels are created through the cloud. The azimuthal fragmentation of a single Laguerre-Gaussian (LG) pulse produces many filaments. Following the lifetime of the plasma, each filament leaves behind an area of high pressure due to the deposited energy. The hydrodynamic expansion of these regions releases shock waves. As shown in FIG. 1A, the superimposed shock waves increase the index of refraction in the region between the filaments. A guiding structure is created with a region of relatively high refractive index surrounded by a ring of lower refractive index; this is referred to Channel 1 (CH1). The outward propagating shock wave clears a transparent channel by expelling the water droplets, creating Channel 2 (CH2). The timescale of this process is on the order of several hundreds of nanoseconds. Residual heat sustains CH1 well past the lifetime of the acoustic waves, as shown in FIG. 1B. The last stage of the structure evolution is illustrated in FIG. 1C, where the transverse refractive index profile of CH1 smoothens out as the heat dissipates. The transition from the second stage to the third stage of evolution can last well into the millisecond range. CH2 has a typical decay lifetime on the order of several milliseconds before collapse as well. Given the lifetime of each channel, a quasi-steady state resembling FIG. 1C can be reached if a high repetition pulse train is used.

Embodiments of the present technology are directed to a systems and methods for effective FSO through air obstructed by cloud and fog. Some embodiments use multi-filament structures to clear a dual channel in the air and guide an LG information signal beam, as shown in FIG. 1. Some embodiments use a 543-nm continuous wave (CW) information signal carried by LG_{0,1}, LG_{4,0}, and LG_{6,0} (FIGS. 1D-1E, respectively) beams generated by a spatial light modulator (SLM) through a 1-m long cloud chamber (1.0×0.3×0.3 m3) using a high-power femtosecond pulse modulated with a spiral phase plate (SPP) to generate multi-filaments. The multi-filaments are embedded with the information signal. The spatial profile of coupled multi-filament structure and the information signal is shown in FIGS. 1G-1I. By utilizing information signals of different dimensions and shapes, the size and structure of each transparent channel can be inferred.

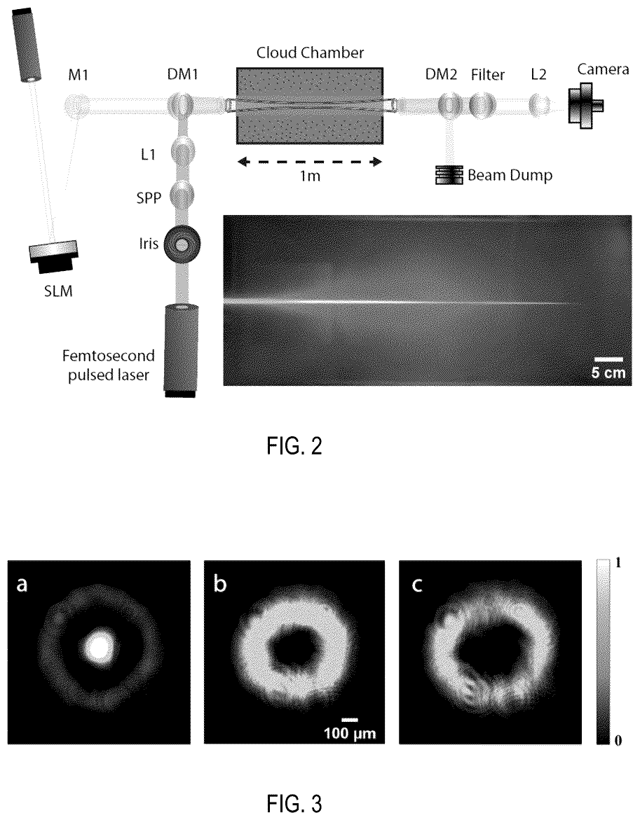

FIG. 2 shows a system for free-space optical communication according to an example embodiment of the present technology. In some embodiments, the femtosecond pulsed laser source is a custom-built Ti:sapphire chirped-pulse amplification system operating at 480-Hz repetition rate and generating pulses of ˜40-fs duration at a ˜800-nm center wavelength. The system is capable of delivering a pulse energy of ˜20 mJ. Vortical beams of topological charge [symbol] =1 and [symbol] =5 are produced by passing a femtosecond Gaussian beam through appropriate fused silica SPPs, which are 1-mm thick and 46-mm wide. Both SPPs have a radial index of zero. In some embodiments, the diameter of the filament driver beam before passing through the SPP is set by an iris, and the beam is then weakly focused using a lens with a focal length f=2.5 m (L1 in FIG. 2). The SPP used to generate the vortex beam of order [symbol] imposes a modulation in the form of exp(i [symbol] Φ), modulo 2π, onto the flat phase front of the filament driver, where Φ represents the azimuthal angle. In some embodiments, the information signal is carried by the LG beam generated with the SLM illuminated by a continuous wave (CW) laser operating at 543 nm. LG phase masks are applied to the SLM to generate vortex beams. Ample spectral separation was achieved from the filament driver by using this wavelength.

In some embodiments, three different LG [symbol] ,p beams with azimuthal order (topological charge) [symbol] =0, 4, and 6 and radial order p=1, 0, and 0 were generated, as shown in FIG. 3. A dichroic mirror (DM1) is used to couple the information signal with the filament driver (FIG. 2). In some embodiments, a meter-long chamber containing an ultrasonic nebulizer was used to simulate cloudy atmospheric conditions. This mist maker produces water droplets with a median diameter of 5.6 μm. A pressure equalization valve was used to keep the chamber at an atmospheric pressure at all times. An air pump was used to create a homogeneous mixture by vacuuming out the top layer of dry air before making a measurement. A hole was drilled on both end of the cloud chamber to allow the filament and signal to pass. The cloud chamber was placed such that the filament exceeded the boundary of the cloud chamber at its entrance and exit. The cloud drastically attenuated the information signal, resulting in a power drop from ˜1.6 μW to ˜60 nW. The measured attenuation coefficient for the cloud at a wavelength λ=543 nm is 14.26 dB/m. In some embodiments, the information signal was collected with a f=15-cm lens and imaged using a sCMOS camera. For each measurement, the information signal was imaged before and after the filament was introduced into the cloud chamber. The camera uses an exposure time of 30 ms, capturing multi-shot images of the information signal. Given the lifetime of the channels as illustrated in FIG. 1, the images represent the time-averaged state of both channels.

While a single filament can clear a channel through cloud, by judiciously arranging multiple filaments, an annular channel (CH1 in FIG. 1) can be generated. Some embodiments use the guiding structure created by a vortical filament driver beam to guide the LG_{0,1} information signal with a “bullseye” intensity profile. A screen is set in front of the DM1 to align the center of the information signal with the phase singularity of the filament driver. Fine adjustments are then made with the camera. Finally, the focusing of the multi-filament structure is adjusted with the iris. The radius of the multi-filament structure increases, with the trade-off being the reduction of pulse energy. This allows the Gaussian spot in the center of the information signal carrier LG_{0,1} to propagate through the CH1 structure without interacting with the filament. This is especially true when the LG_{1,0} SPP is used, owing to the smaller diameter of the filament driver beam.

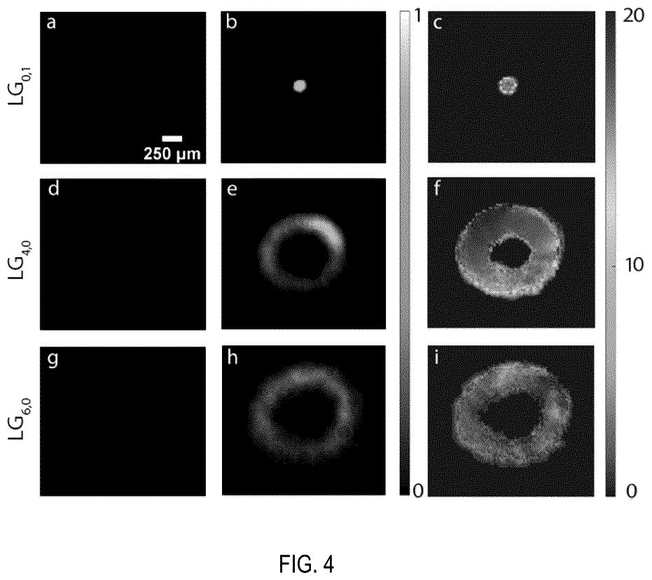

In some embodiments, to investigate the transmission of information signal carried by an LG beam through a cloud, a multi-filament structure longer than 1 m (FIG. 2) was generated. The filaments are generated by a vortex beam of order [symbol] =1 after passing the SPP. First, the information signal LG_{0,1} is generated and the vortical filament driver beam and the information signal are transmitted through the chamber. The results of the experiment are shown in FIG. 4. FIGS. 4A, 4D, and 4G show the normalized intensity profile of the information signal carriers (LG0,1, LG_{4,0}, and LG_{6,0}, respectively), after propagating through the cloud alone. The information signal with filament present is shown in FIGS. 4B, 4E, and 4H. The information signal is imaged by the same detector at the same position, with identical exposure time. For each vortex beam, the enhancement factor is obtained by taking the ratio of the intensity profiles with filament present and that without the filament. The results are visualized in FIGS. 4C, 4F, and 4I. It is evident from FIG. 4 that the intensity of information signal is significantly increased. The information signal carried by LG_{4,0} and LG_{6,0} beams propagates through the quasi-transparent CH2 without any apparent defocusing. The LG_{0,1} beam utilizes the CH1 structure between the filaments. FIGS. 4B-4C demonstrate that the Gaussian center is not defocused. This is a significant improvement over using a single filament.

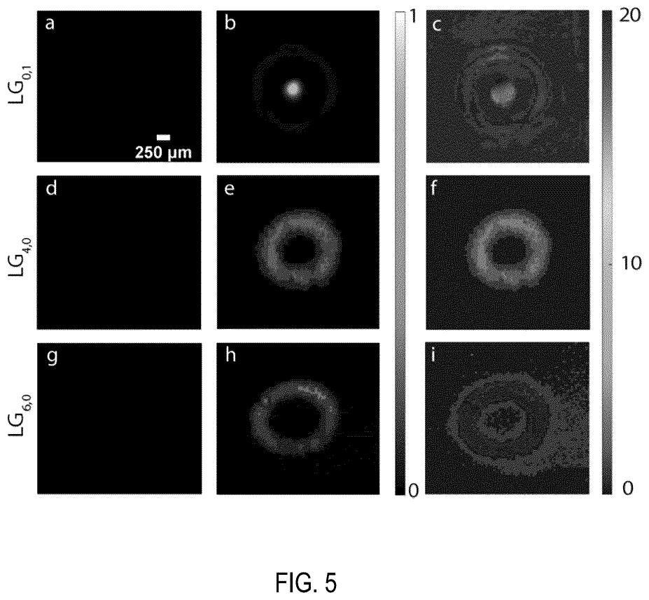

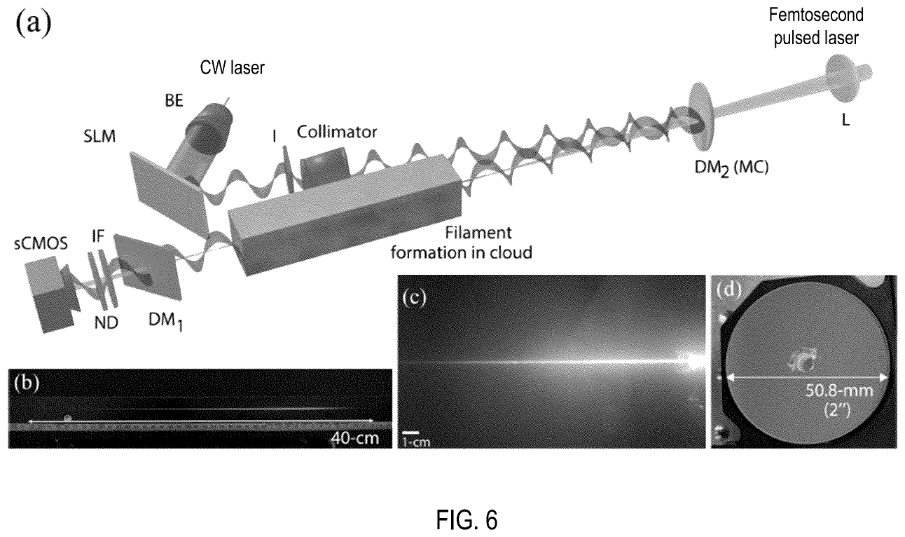

Some embodiments repeated these measurements by replacing the vortex beam of order [symbol] =1 (SPP−1) by a vortical beam of [symbol] =5 (SPP−5). The choice of [symbol] =5 is not due to specific characteristics of the vortical beam but due to availability of the SPP. The results are shown in FIG. 5. The left column (FIGS. 6A, 6D, and 6G) shows the transmitted information signal carrier through the cloud in the absence of the filaments; the middle column (FIGS. 6B, 6E, and 6H) shows the transmitted information signal in the presence of the filaments; and the right column (FIGS. 6C, 6F, and 6I) shows the enhancement of the transmission through the cloud by information signal carriers LG_{0,1}, LG_{4,0} and LG_{6,0}. As shown, the information signal carried by LG_{4,0} is transmitted without significant distortion, while the LG_{6,0} and LG_{0,1} show a scattering pattern. The Gaussian spot at the center of the LG_{0,1} beam shows a clear enhancement.

As shown in FIG. 5, in both vortical filaments of order [symbol] =1 and [symbol] =5, the information signal carried by LG_{4,0} is clearly transmitted. The same level of transmission was not achieved for the Gaussian spot at the center of LG_{0,1}. In both cases, CH2 and CH1 are sufficiently large to allow their transmission. Therefore, the size of CH2 and CH1 is wider than the external diameter of the LG_{4,0} and that of the Gaussian spot at the center of LG_{0,1}, respectively. In the case of the LG_{0,1} beam shown in FIG. 5C, the Gaussian center shows clear enhancement, but the ring-shaped beam is scattered. Given the dimensions of the water droplets, it can be assumed that Mie scattering is the dominant form of scattering. The LG_{6,0} beam also shows clear signs of Mie scattering.

The information signal LG_{6,0} is transmitted with little distortion through the cloud using CH2 cleared by the LG_{1,0} filament driver (FIG. 4I), while it is weakly scattered through the CH2 cleared by LG_{5,0} (FIG. 5I). Likewise, the ring of LG_{0,1} is completely blocked when propagating through the CH2 cleared by LG_{1,0}, but it is transmitted with a slight occurrence of scattering when using LG_{5,0}. The critical power [symbol] _{cr} increases to form multi-filaments with increasing topological charge, resulting in shorter filaments. This effect may cause the tail end of the multi-filament to be ineffective in sustaining the quasi-transparent CH2. In some embodiments, this affected the larger diameter beams, while the smaller LG_{4,0} beam was unaffected. Thus, CH2 and CH1 cleared by LG_{5,0} beam are wider than those created by LG_{1,0}.

FIG. 6 shows a system for free-space optical communication according to another example embodiment of the present technology. Some embodiments utilize the channel cleared by a high-repetition-rate laser filament in the cloud to demonstrate unobstructed transmission of [symbol] beams. The donut-shaped intensity distribution of [symbol] light allows co-propagation with the filament without interference between the two beams. The LG beam as an information carrier can be modulated in amplitude and phase, and information can also be encoded in its orbital angular momentum (OAM) states for increased secure communication. The dimensions of the cleared channel ranging greater than 1 mm in diameter allows transmission of various donut-shaped beams. Hence, one can transmit any LG beam with a diameter smaller than that of the cleared channel. In some embodiments, LG_{12,0} was selected to be the upper threshold.

The system shown in FIG. 6 is based on using the channel generated by the femtosecond pulse through a cloud chamber to transmit a signal carried by an LG beam. In some embodiments, a Ti:Sapphire (wavelength centered at 810-nm) pulsed laser with a pulse duration of 52-fs, 1.67-mJ energy/pulse, and 3-kHz repetition rate is focused by a 2-m focal length anti-reflection (AR) coated lens. The signal is generated from a continuous wave (CW), single longitudinal mode diode laser with 635-nm wavelength. In some embodiments, the signal beam is collimated and expanded using a beam expander (BE). The diameter of the beam is chosen so that it covers the entire face of the spatial light modulator (SLM), which in some embodiments is a phase-only modulator. In some embodiments, various holographic masks are displayed on the SLM to generate the desired structured light beams. An iris (I) is used to block the undesired part of the signal. To allow extra flexibility and ensure that the annular beam fits well within the cleared channel, the generated beam is expanded and collimated using a collimator consisting of two spherical lenses. The filament and the signal are coupled using a homemade mirror coupler (MC) as shown in FIG. 6A. The MC is a gold plane mirror built on the fused silica substrate. It is 2-in. (50.8-mm) in diameter. In the center, the MC has a hole of ˜2:65-mm in radius. This MC is used to couple the signal and the femtosecond pump through the air. The information beam was widened to increase the inner diameter of the LG beam. The MC is placed in a position where the entire femtosecond beam passes through the hole. The advantage of using an MC as opposed to a traditional beam combiner is that the femtosecond beam in its entirety is utilized to produce the filament. Generally, the increase in the pump power will result in a filament with higher plasma density. The pump generates a filament >50-cm length in air. The white glowing line shown in FIG. 6C illustrates a side view of the generated filament. A ruler is placed behind the filament as a reference. To couple the signal with the filament through the cloud, in some embodiments a dichroic mirror (DM2) was used. Both the filament and the LG beam propagate through a cloud chamber of dimensions 40×30×15-cm3. The length of the chamber is chosen to have at most 5-cm of the filament on either side of the cloud chamber (see FIG. 6B) to avoid the signal being scattered by the outflow mist. Two holes of 1-cm in diameter are made on either side of the chamber to let the light in and out. The chamber is made using Acrylic Plexiglass, a transparent material. The cloud is generated using an ultrasonic nebulizer. A pressure equalization valve keeps the chamber at atmospheric pressure. One meter after the cloud chamber, the LG beam signal coupled with the femtosecond beam (no longer a filament) is filtered by a dichroic mirror (DM) and two interference filters (IF). A variable neutral density (ND) filter is positioned before the sCMOS to attenuate the signal and avoid damaging the camera. To measure the transmitted signal, some embodiments replaced the sCMOS camera with a photomultiplier module (PMT) and added (behind the ND filter) a lens (f ¼ 5-cm) to fit the beam in the PMT aperture.

The filament length is limited by the pulse energy. Some embodiments produced filaments of >50-cm in length. The critical power (P_{cr}) for filamentation to occur is governed by:

$${P}_{cr} = \frac{{λ}^{2}}{8 π {Cn}_{0} {n}_{2}} , \qquad ( 1 )$$

where λ is the wavelength of the laser, C is the numerical factor defined by the beam profile, no is the refractive index of the medium (air), and n₂ is the nonlinear refractive index due to the optical Kerr effect. The critical power for a Gaussian beam centered at 800 nm is 3.19 GW. The laser produces pulses with a peak power of 33.4 GW. This significantly large peak power allows the formation of a long filament. Adjustments to pulse compression and energy can be used to vary the length of the filament. The Laguerre-Gaussian beam is the first solution to the paraxial wave equation in cylindrical coordinates (ρ, ϕ, z). The general expression of its amplitude distribution is given by:

$$LG ( ρ , ϕ ) = \text{?} \times \text{?} \times \text{?} , \qquad ( 2 )$$

$$\text{?} = \frac{\text{?}}{\text{?}} \times ( \sqrt{2} ρ \text{?} \times \text{?} ( 2 {ρ}^{2} ) \times \text{?} ,$$

$$\text{?} ( ρ , z ) = \frac{\text{?}}{R} + ( \vert ℓ \vert + 2 \text{?} + \text{?} ) arctan ( z / \text{?} ) ,$$

$$ρ = \frac{\text{?}}{\text{?}} .$$

$$\text{?} \text{indicates text missing or illegible when filed}$$

The parameters are as follows: k, wave-number; z₀, Rayleigh range; p, radial order integer; [symbol] , topological charge; [symbol] , generalized Laguerre polynomials; w(z), beam waist;

$$w ( z ) = {w}_{0} \sqrt{1 + {( \frac{z}{{z}_{R}} )}^{2}} ;$$

R, wave-front radius; and [symbol] , normalization constant. [symbol] describes the helical phase structure of the light, which carries orbital angular momentum [symbol] ℏ per photon. The phase singularity at the center of a vortex beam along its propagation axis gives the beam a spatial intensity profile that ensures no light is directly interacting with the filament. The LG beam is produced by illuminating a phase mask displayed on the SLM. In some embodiments, the phase mask or the hologram is computer generated. The inner diameter of the intensity profile of the LG beam is related to its topological charge ( [symbol] ) and the beam waist (w) by w\sqrt{2}. By using DM2, some embodiments couple the filament and the signal carried by the LG beam with [symbol] =12 (noted LG_{12,0}) through the cloud. To have an intense signal, the signal is shrunk down, the center of the donut beam matches the axis of the filament, and the diameter of the shrunk beam is smaller than 1-cm, the chamber side holes.

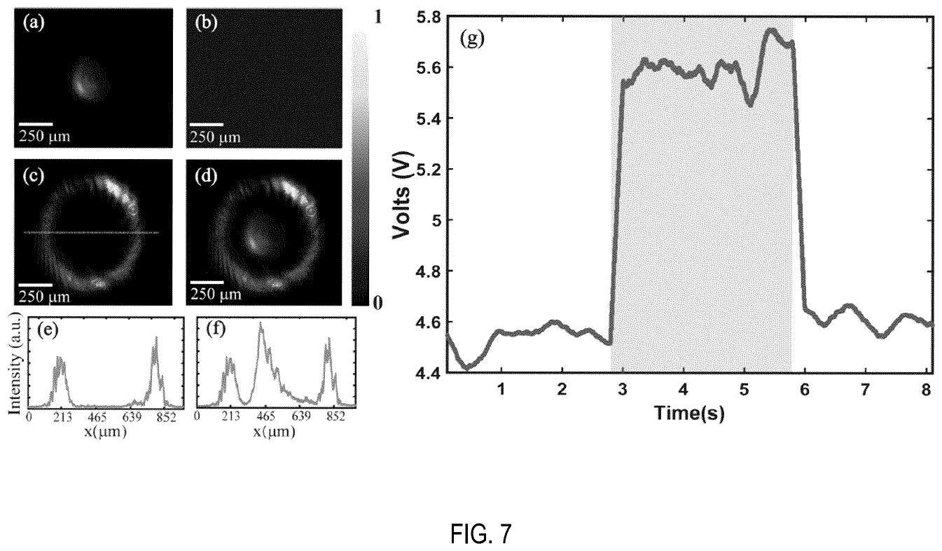

FIG. 7 shows the procedures to demonstrate that the signal beam is transmitted virtually unobstructed in the cloud chamber when coupled with the filament. For all the measurements, the exposure time of the sCMOS camera was fixed and remained unchanged. FIG. 7A shows the femtosecond filament after it is transmitted alone through the cloud-filled chamber. Neutral density filters were used to ensure that the filament intensity is attenuated by several orders of magnitude before it is imaged. While the chamber is still cloud-filled, the femtosecond beam is blocked and the signal beam is turned on. As expected, most of the signals are scattered as shown in FIG. 7B. The signal beam when transmitted in free space is captured in FIG. 7C. Next, both the filament and signal beam propagate through the cloud-filled chamber. FIG. 7D shows the imaged resulting intensity distribution of the coupled signals. It is clear that the signal is transmitted unobstructed through the transmission channel created by the filament. The intensity profile of the signal in free space is plotted in FIG. 7E, and FIG. 7F plots the signal coupled with the filament transmitted through the cloud. The transmission of the signal through the cloud chamber is further characterized by replacing the sCMOS with a PMT. The PMT was connected to an oscilloscope to monitor the variation of the signal beam. The signal intensity is read in voltage: the minimum transmission is 4.4-V and the maximum is 5.8-V. This is equivalently measured by a power meter to correspond to 68-nW for the minimum signal transmitted and 130-nW for the maximum. The presence of the filament increases the transmitted signal by over 90%. To characterize the cleared channel time, the pump beam (femtosecond beam) is blocked and unblocked in 3 s intervals. The shaded area in FIG. 7G highlights the time that the filament is unblocked. When the filament is blocked, the signal beam is completely obstructed. When the pump is unblocked, the intensity of the signal increases before reaching a maximum. Likewise, when the pump is off, the intensity of the signal drops down before it reaches the background level. The time interval that the signal intensity requires to reach the maximum when the pump is unblocked is close to that necessary to reach the ground when the pump is blocked. In other words, FIG. 7G shows that the rise time for the transmitted signal to reach its maximum is comparable to the fall time at which the signal vanishes. In some embodiments, the rise and fall time is equivalent to the cleared channel lifetime, which was measured to be ˜12-ms. This transmission plot also highlights that the significant drops in transmission are not present in the case of a donut-shaped beam compared to a gaussian information carrier. Right after the channel is established, a fast, short, and small transmission drop is observed. These short fluctuations are due to the dynamic nature of the cleared channel. These fluctuations are expected to be much lower in clouds found in the atmosphere, which are significantly lower in density than the ones produced in the cloud chamber. The high repetition rate of the laser makes those fluctuations short and small. Most of the energy deposited by the femtosecond pulse in the plasma is used to generate the shock waves.

The signal-to-noise ratio (SNR) to estimate the density of the cleared channel is characterized by:

$$SNR = 20 \times {log}_{10} ( \frac{Signal}{Noise} ) \qquad ( 3 )$$

The SNR is defined as a ratio between the signal intensity coupled to the pump that generates the filament and the intensity of the noise when the signal is blocked and the pump is left on. Across all measurements, the signal power is kept constant. When the channel is well established, the SNR defined by Eq. (3) is ˜1.7-dB. By scanning across the diameter of the intensity profile of the signal (LG_{12,0}) alone (FIG. 7E) and then coupled to the pump (FIG. 7F), no crosstalk was noted. The density of the cloud is such that it does not allow signal transmission without the filament. When the transmission channel is established, an ˜90% increase signal in transmission through the cloud was estimated. Embodiments demonstrate the ability to transmit data carried by an LG beam with an adjustable repetition rate through a dense cloud with nearly zero initial transmission. There are further advantages in using light-carrying OAM and signal beam, one of which is to encode information within the OAM degree of freedom of the signal beam higher dimensional telecommunication. To demonstrate the conservation of the OAM through the cloud, the topological charge ( [symbol] ) of the signal beam is measured using the tilted spherical lens. A spherical lens is used to transform an [symbol] mode into a Hermite-Gaussian (HG_{m,n}) mode. [symbol] is determined by counting the bright fringes (N) of the HG_{m,n}: [symbol] =N−1.

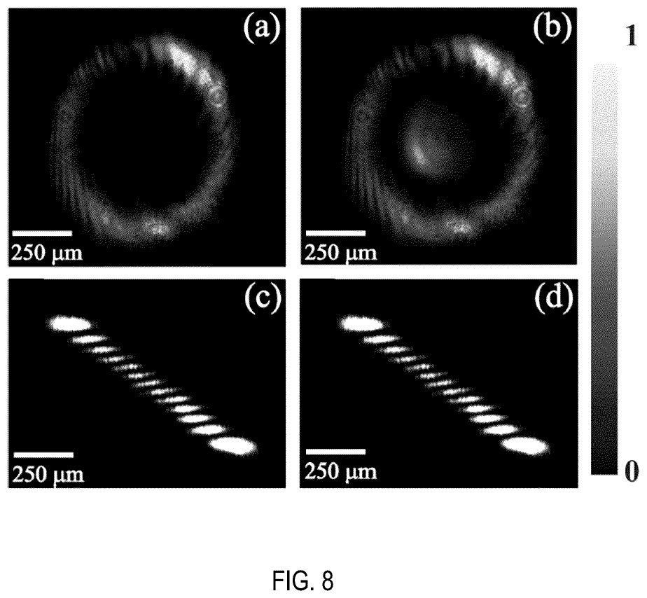

FIG. 8 shows the mode conversion between the LG mode and the HG mode. FIG. 8A shows the LG_{12,0} light signal in air and its corresponding HG mode is shown in FIG. 8C. The light signal coupled with the filament after it has traveled through the cloud chamber is shown in FIG. 8B, and its corresponding HG beam after mode conversion is displayed in FIG. 8D. Thus, the OAM state of the signal beam is not affected in cloudy conditions when propagated together with the filament. In some embodiments, for a channel diameter of 10-μm, a filament diameter of ˜4-cm is produced and propagates for several kilometers in the atmosphere.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about.” The term “about” can refer to a variation of +5%, +10%, +20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the technology encompasses not only the entire group listed as a whole, but each member of the group individually and all possible subgroups of the main group. Additionally, for all purposes, the technology encompasses not only the main group, but also the main group absent one or more of the group members. The technology therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. A system for free-space optical communication comprising:
a first light source configured to emit an information signal;
a spatial light modulator configured to shape the information signal;
a second light source configured to emit a plurality of beam pulses;
at least one spiral phase plate configured to convert each of the plurality of beam pulses into a plurality of vortical beam filaments; and
a mirror coupler configured to combine the information signal and the plurality of vortical beam filaments to form a multi-filament beam having the plurality of vortical beam filaments embedded within the information signal;
wherein when the multi-filament beam passes through an optically obstructed space the plurality of vortical beam filaments are configured to clear at least one channel in the optically obstructed space for the information signal to pass through.

2. The system of claim 1, wherein the spatial light modulator has a Laguerre-Gaussian phase mask applied thereon for shaping the information signal.

3. The system of claim 1, wherein the at least one spiral phase plate is a fused silica phase plate.

4. The system of claim 1, further comprising an iris positioned between the second light source and the at least one spiral phase plate, the iris configured to set a diameter of the beam pulses.

5. The system of claim 1, wherein the first light source is a continuous wave laser.

6. The system of claim 1, wherein the second light source is a femtosecond pulsed laser.

7. The system of claim 1, wherein the at least one channel is substantially cylindrical.

8. The system of claim 1, wherein the mirror coupler is a dichroic mirror.

9. The system of claim 1, further comprising a beam expander positioned between the first light source and the spatial light modulator, and a collimator positioned between the spatial light modulator and the mirror coupler.

10. The system of claim 1, wherein the information signal has an annular profile.

11. The system of claim 1, wherein the optically obstructed space comprises a gaseous medium saturated with condensed water vapor.

12. A method of free-space optical communication comprising:
emitting an information signal from a first light source;
shaping, via a spatial light modulator, the information signal;
emitting a plurality of beam pulses from a second light source;
converting, via at least one spiral phase plate, each of the plurality of beam pulses into a plurality of vortical beam filaments;
combining, via a mirror coupler, the information signal and the plurality of vortical beam filaments to form a multi-filament beam having the plurality of vortical beam filaments embedded within the information signal; and
directing the multi-filament beam through an optically obstructed space;
wherein when the multi-filament beam passes through the optically obstructed space the plurality of vortical beam filaments clear at least one channel in the optically obstructed space for the information signal to pass through.

13. The method of claim 12, wherein the spatial light modulator has a Laguerre-Gaussian phase mask applied thereon for shaping the information signal.

14. The method of claim 12, wherein the at least one spiral phase plate is a fused silica phase plate.

15. The method of claim 12, wherein the first light source is a continuous wave laser.

16. The method of claim 12, wherein the second light source is a femtosecond pulsed laser.

17. The method of claim 12, wherein the at least one channel is substantially cylindrical.

18. The method of claim 12, wherein the mirror coupler is a dichroic mirror.

19. The method of claim 12, wherein the information signal has an annular profile.

20. The method of claim 12, wherein the optically obstructed space comprises a gaseous medium saturated with condensed water vapor.
